(19) United States
(12) Patent Application Publication
(10) Pub. No.: US 2014/0055717 A1
(43) Pub. Date: Feb. 27, 2014

(54) Systems and Methods for Preventing Light Guide Plate Scratching Artifacts

(71) Applicant: APPLE INC., Cupertino, CA (US)

(72) Inventors: Eric L. Benson, Cupertino, CA (US); Jun Qi, Cupertino, CA (US); Victor H. Yin, Cupertino, CA (US)

(73) Assignee: APPLE INC., Cupertino, CA (US)

(21) Appl. No.: 13/974,618

(22) Filed: Aug. 23, 2013

Related U.S. Application Data
(60) Provisional application No. 61/693,132, filed on Aug. 24, 2012.

(51) Int. Cl. F21V 8/00

(52) U.S. Cl. CPC G02B 6/0093
USPC 349/64; 362/606; 156/60

(57) ABSTRACT

Systems, methods, and devices for preventing scratching artifacts on a light guide plate of a backlight are provided. In one example, an electronic device may include a processor to generate image data and a display to display the image data. The display may include a liquid crystal display panel and a backlight unit. A light guide plate and a diffuser of the backlight may be separated at least partly by a light guide plate scratch protection component. The light guide plate scratch protection component may be a pattern of molded convex bumps on the light guide plate, a self-healing coating, a nonstick (e.g., Teflon) coating, or some combination of these surfaces.

### CROSS-REFERENCE TO RELATED APPLICATIONS

This application claims the benefit of U.S. Provisional Application No. 61/693,132, “Systems and Methods for Preventing Light Guide Plate Scratching Artifacts,” filed 24 Aug. 2012, which is incorporated by reference herein in its entirety.

### BACKGROUND

The present disclosure relates generally to backlighting for electronic displays and, more particularly, to preventing scratching artifacts on a light guide plate of a backlight unit.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic displays commonly appear in electronic devices such as televisions, computers, and phones. One type of electronic display, known as a liquid crystal display (LCD), displays images by modulating the amount of light allowed to pass through a liquid crystal layer within pixels of the LCD. In general, LCDs modulate the light passing through each pixel by varying a voltage difference between a pixel electrode and a common electrode. This creates an electric field that causes the liquid crystal layer to change alignment. The change in alignment of the liquid crystal layer causes more or less light to pass through the pixel. By changing the voltage difference (often referred to as a data signal) supplied to each pixel, images are produced on the LCD.

LCD pixels do not produce their own light. Rather, a backlight unit lights the LCD pixels from behind. The backlight unit may include a light source, a light guide plate, and a diffuser. The light source emits light into the light guide plate, which distributes the light across the diffuser. The diffuser diffuses the light into the LCD. Since the materials that form the light guide plate and the diffuser may stick to one another, a binder material and beads may be placed between the light guide plate and the diffuser to perform an anti-wetting function. During vibration reliability testing or certain real-world use cases, however, the beads could scratch the light guide plate. When the beads scratch the light guide plate, undesirable display screen artifacts appearing as white spots may occur.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to systems, methods, and devices for preventing scratching artifacts on a light guide plate of a backlight. In one example, an electronic device may include a processor to generate image data and a display to display the image data. The display may include a liquid crystal display panel and a backlight unit. A light guide plate and a diffuser of the backlight may be separated at least partly by a light guide plate scratch protection component. The light guide plate scratch protection component may be a pattern of molded convex bumps on the light guide plate, a self-healing coating, a nonstick (e.g., Teflon) coating, or some combination of these surfaces.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device with a display protected from artifacts due to light guide plate scratching, in accordance with an embodiment;

FIG. 2 is a perspective view of an example of the electronic device of FIG. 1 in the form of a notebook computer, in accordance with an embodiment;

FIG. 3 is a is a front view of an example of the electronic device of FIG. 1 in the form of a handheld electronic device, in accordance with an embodiment;

FIG. 4 is a perspective cut-away view of the electronic display of the electronic device, in accordance with an embodiment;

FIG. 5 is a is a perspective cut-away view of the components of a backlight unit of the electronic display, in accordance with an embodiment;

FIG. 6 is a schematic view of a light guide plate and diffuser of the backlight unit, in which the light guide plate includes a molded pattern to prevent scratching artifacts, in accordance with an embodiment;

FIG. 7 is a flowchart of a method for manufacturing the backlight unit of FIG. 6, in accordance with an embodiment;

FIG. 8 is a schematic view of light guide plate and the diffuser of the backlight unit, in which a nonstick (e.g., Teflon) or self-healing coating on the light guide plate prevents scratching artifacts, in accordance with an embodiment; and

FIG. 9 is a flowchart of a method for manufacturing the backlight of FIG. 8, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

This disclosure relates to preventing display artifacts in a backlight display. Many electronic displays, such as liquid crystal displays (LCDs), rely on a backlight unit for lighting. Such a backlight unit may include a light source, a light guide plate, and a diffuser, among other things. The light source may emit light into the light guide plate, which may distribute the light to the diffuser. The diffuser may diffuse the light into the LCD. During the manufacture of the backlight unit, the light guide plate may be attached to the diffuser using a binder material and beads. The binder material binds the diffuser and the light guide plate to one another, while the beads may perform an anti-wetting function to prevent the light guide plate and diffuser from disadvantageously sticking together.

As described in this disclosure, an additional component on the surface of the light guide plate, at the interface between the light guide plate and the diffuser, may prevent the beads and/or the diffuser from scratching the light guide plate. This scratch-preventing component may represent a pattern molded onto the light guide plate and/or a protective layer applied to the light guide plate. The molded pattern may be similar to a corresponding pattern on the opposite side of the light guide plate (i.e., the side of the light guide plate opposite that of the interface of the light guide plate and the diffuser). In many cases, however, the molded pattern may be smaller (e.g., having convex bumps having diameters of less than 35 μm). The protective layer may represent a nonstick (e.g., Teflon) or self-healing coating. A nonstick coating such as Teflon may form a protective barrier over the light guide plate so that, if the beads move across the light guide plate, the beads do not penetrate the relatively softer material of the light guide plate. In addition, the nonstick coating may result in less friction with the beads than may occur when the beads contact the light guide plate material directly. A self-healing coating may allow the beads to penetrate the self-healing coating, but any scratches may be short-lived. Indeed, when the beads and/or the diffuser scratch the self-healing coating on the light guide plate, the self-healing coating may self-heal over the scratch location.

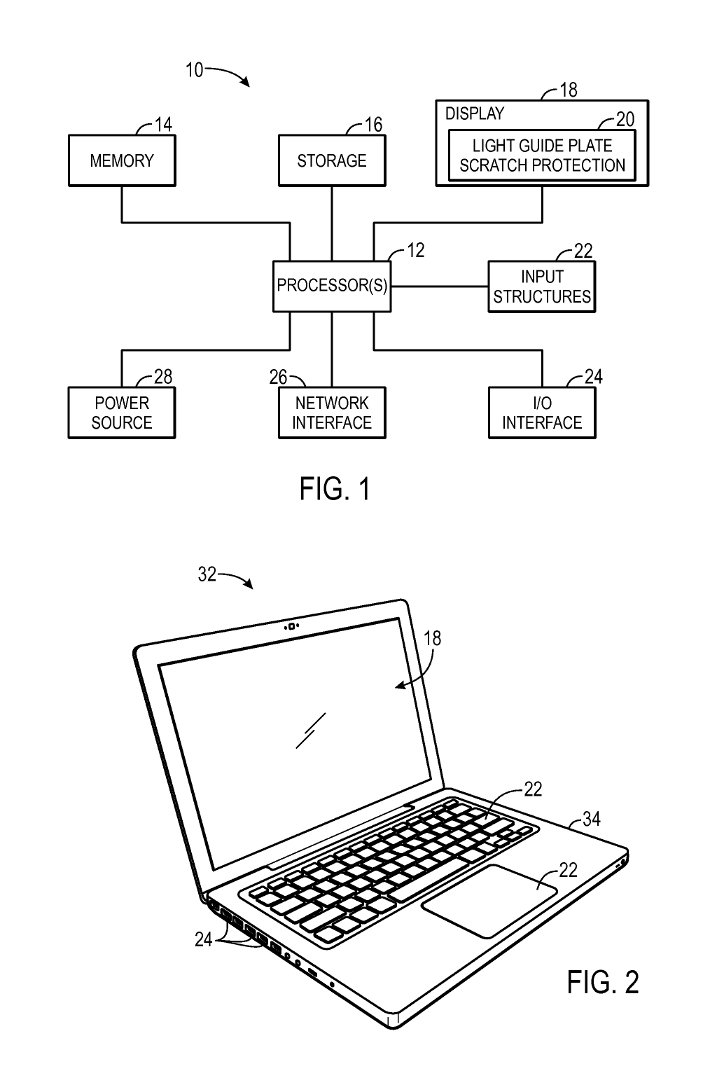

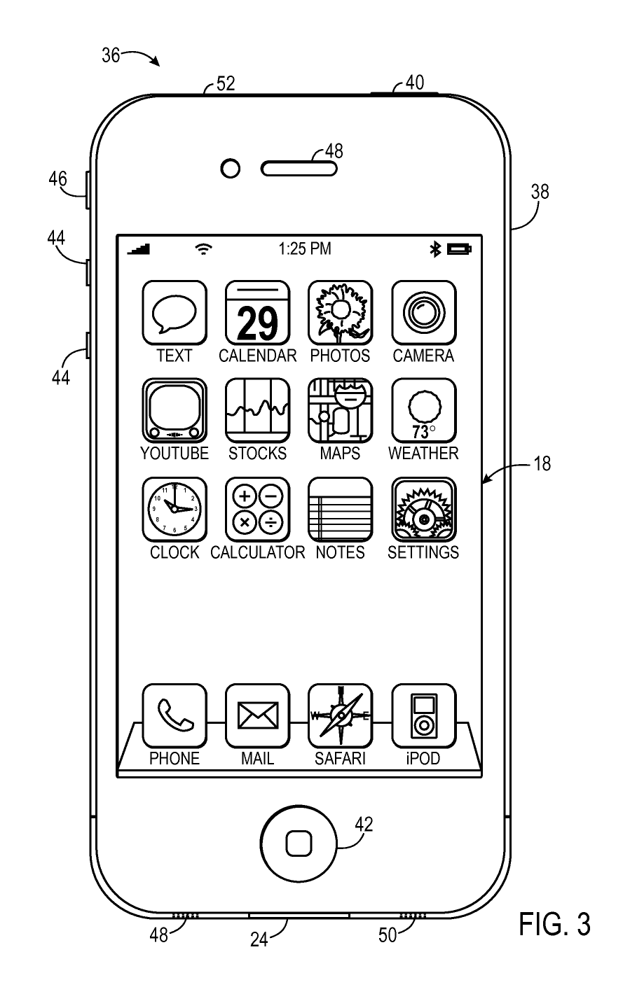

With the foregoing in mind, many suitable electronic devices may employ electronic displays with such backlight units. For example, FIG. 1 is a block diagram depicting various components that may be present in an electronic device suitable for use with such a display. FIGS. 2 and 3 respectively illustrate perspective and front views of a suitable electronic device. Specifically, FIGS. 2 and 3 illustrate a notebook computer and a handheld electronic device, respectively.

Turning first to FIG. 1, an electronic device 10 according to an embodiment of this disclosure may include, among other things, one or more processor(s) 12, memory 14, nonvolatile storage 16, a display 18, input structures 22, an input/output (I/O) interface 24, network interfaces 26, and/or a power source 28. The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in the electronic device 10.

By way of example, the electronic device 10 may represent a block diagram of the notebook computer depicted in FIG. 2, the handheld device depicted in FIG. 3, or similar devices. In the electronic device 10 of FIG. 1, the processor(s) 12 and/or other data processing circuitry may be operably coupled with the memory 14 and the nonvolatile memory 16 to execute instructions. For instance, the processor(s) 12 may generate image data to be displayed on the display 18. The display 18 may be a touch-screen liquid crystal display (LCD). In some embodiments, the electronic display 18 may be a Multi-Touch™ display that can detect multiple touches at once.

The display 18 may include a backlight unit that uses a light guide plate having a light guide plate scratch protection component 20. The light guide plate scratch protection component 20 may protect the light guide plate of the display 18 from becoming scratched, thereby reducing the likelihood of a white spot artifact on the display 18. The light guide plate scratch protection component 20 may include a molded pattern on the light guide plate, a nonstick (e.g., Teflon) coating on the light guide plate, and/or a self-healing coating on the light guide plate.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interfaces 26. The network interfaces 26 may include, for example, interfaces for a personal area network (PAN), such as a Bluetooth network, for a local area network (LAN), such as an 802.11x Wi-Fi network, and/or for a wide area network (WAN), such as a 3G or 4G cellular network. The power source 28 of the electronic device 10 may be any suitable source of power, such as a rechargeable lithium polymer (Li-poly) battery and/or an alternating current (AC) power converter.

The electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a notebook computer 32, is illustrated in FIG. 2 in accordance with one embodiment of this disclosure. The depicted computer 32 may include a housing 34, a display 18, input structures 22, and ports of an I/O interface 24. In one embodiment, the input structures 22 (such as a keyboard and/or touchpad) may be used to interact with the computer 32, such as to start, control, or operate a GUI or applications running on computer 32.

FIG. 3 depicts a front view of a handheld device 36, which represents one embodiment of the electronic device 10. The handheld device 36 may represent, for example, a portable phone, a media player, a personal data organizer, a handheld game platform, or any combination of such devices. By way of example, the handheld device 36 may be a model of an iPod® or iPhone® available from Apple Inc. of Cupertino, Calif. In other embodiments, the handheld device 36 may be a tablet-sized embodiment of the electronic device 10, which may be, for example, a model of an iPad® available from Apple Inc.

The handheld device 36 may include an enclosure 38 to protect interior components from physical damage and to shield them from electromagnetic interference. The enclosure 38 may surround the display 18. The I/O interfaces 24 may open through the enclosure 38 and may include, for example, a proprietary I/O port from Apple Inc. to connect to external devices.

User input structures 40, 42, 44, and 46, in combination with the display 18, may allow a user to control the handheld device 36. For example, the input structure 40 may activate or deactivate the handheld device 36, the input structure 42 may navigate a user interface to a home screen, a user-configurable application screen, and/or activate a voice-recognition feature of the handheld device 36, the input structures 44 may provide volume control, and the input structure 46 may toggle between vibrate and ring modes. A microphone 48 may obtain a user's voice for various voice-related features, and a speaker 50 may enable audio playback and/or certain phone capabilities. A headphone input 52 may provide a connection to external speakers and/or headphones.

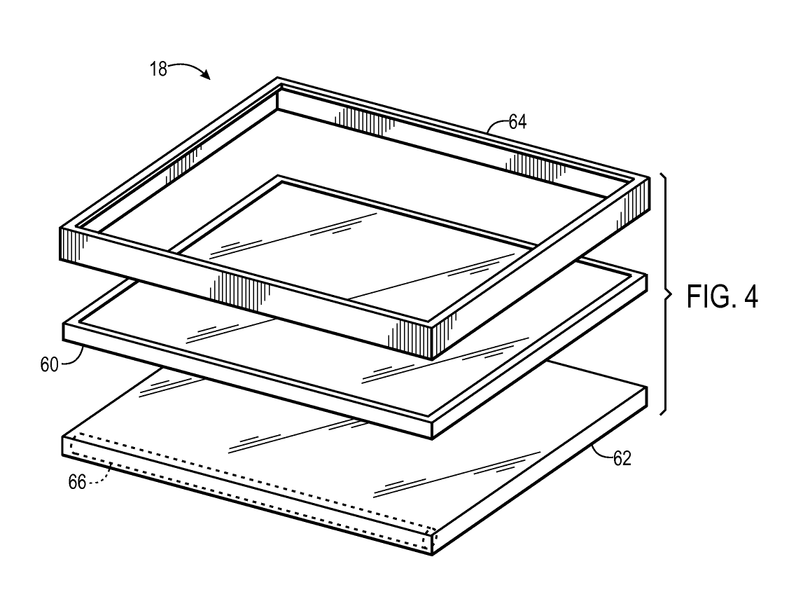

One example of the display 18 appears in cut-away form in FIG. 4. The display 18 generally includes an LCD panel 60 and a backlight unit 62, which may be assembled within frame 64. As may be appreciated, the LCD panel 60 may include numerous pixels that selectively modulate the amount and color of light passing from the backlight unit 62 through the LCD panel 60. The LCD panel 60 may employ any suitable liquid crystal display architecture, such as twisted nematic (TN), in-plane switching (IPS), fringe-field switching (FFS), and/or vertical alignment (e.g., multi-domain vertical alignment (MVA) or patterned vertical alignment (PVA)). The backlight unit 62 supplies the light that illuminates the LCD panel 60. This light derives from a light source 66, which is routed through portions of the backlight unit 62 before being emitted toward the LCD panel 60. The light source 66 may include a cold-cathode fluorescent lamp (CCFL), one or more light emitting diodes (LEDs), or any other suitable source of light.

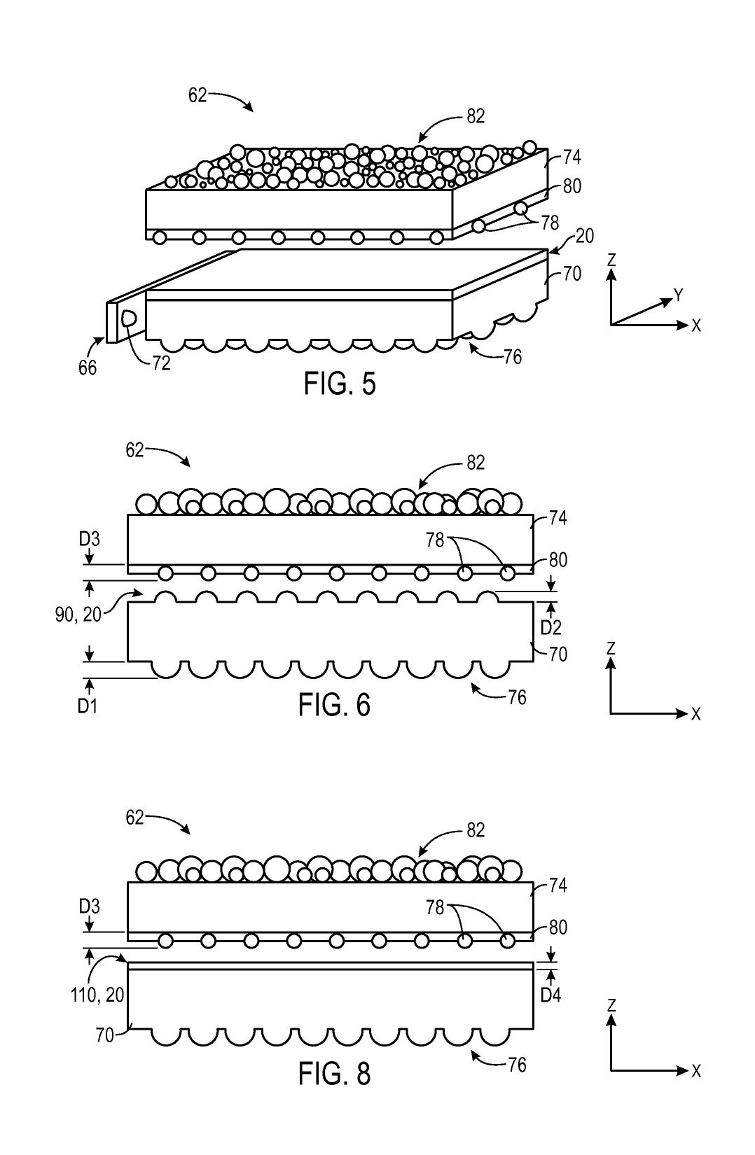

The backlight unit 62 may include a variety of individual layers and components. Some these layers and components appear in a perspective cut-away view of the backlight unit 62 that appears in FIG. 5. The perspective view of FIG. 5 focuses on the interface between a light guide plate 70 that receives light from the light source 66 (e.g., via light-emitting diodes (LEDs) 72) and a diffuser 74. As such, it should be appreciated that the backlight unit 62 may include other layers and components disposed above and below those shown in FIG. 5. Moreover, the light guide plate 70 and the light diffuser 74 are shown in a cut-away form, in which these components are separated from one another. When the backlight unit 62 is manufactured, however, the light guide plate 70 and the light diffuser 74 are joined together. For ease of explanation, the backlight unit 62 may be described in relation to a coordinate system (x, y, z). Points higher in the z-direction may be referred to as “above,” “higher,” “on top of,” and so forth. Points lower in the z-direction may be referred to as “beneath,” “lower,” “below,” and so forth.

To provide light to the LCD panel 60, the light source 66 may supply light to the light guide plate 70. The light may pass through the light guide plate 70 via total internal reflection until exiting the light guide plate 70 to enter the diffuser 74. A light guide plate pattern 76 may be molded on the bottom of the light guide plate 70 (i.e., the side of the light guide plate that faces away from the interface between the light guide plate 70 and the diffuser 74). The molded pattern 76 on the light guide plate 70 may cause light to disrupt the total internal reflection of the light passes through the light guide plate 70, causing the light to pass from the light guide plate 70 up into the diffuser 74. The light guide plate 70 is depicted in FIG. 5 as taking a generally planar shape. In other embodiments, however, the light guide plate 70 may have a generally wedge shape, in which the thickness (e.g., in the z-direction) may decrease farther from the light source 66 (e.g., in the x-direction).

Any suitable material may form the light guide plate 70 and the diffuser 74. In one example, the light guide plate 70 and/or the diffuser 74 may be formed from polymethyl-methacrylate, an acrylic glass commonly referred to as “PMMA.” In some embodiments, the diffuser plate 74 may be formed from polyethylene terephthalate (PET). The light guide plate 70 and the diffuser 74 may be formed from other materials in other embodiments. Moreover, although the light guide plate 70 is schematically shown to take a similar size as the diffuser 74, the light guide plate 70 may be substantially larger. For instance, the light guide plate 70 may have a thickness (in the z-direction) of approximately 0.7 mm, while the diffuser 74 may have a thickness of approximately 0.095 mm.

To join the light guide plate 70 and the diffuser 74, beads 78 and a binder material 80 may be disposed on the diffuser 74 at the interface between the diffuser 74 and the light guide plate 70. The beads 78 may be formed from a material such as nylon. Such nylon material may be relatively soft so as to reduce unnecessary scratching due to the hardness of the beads 78. The binder material 80 may be, for example, a heat cure or ultraviolet (UV) cure binder material. The binder material 80 and the beads 78 may prevent the light guide plate 70 and the diffuser 74 from sticking together and producing certain display artifacts. The beads 78 and the binder material 80 may perform a function referred to as anti-wetting. The upper face of the diffuser 74 may include a number of printed dots 82 or micro-lenses that can scatter light over a broad range of distribution. The dots 82 may be beads of varying sizes (e.g., 3 μm and 6 μm) and/or materials (e.g., acrylic and/or polystyrene). Although not shown in FIG. 5, additional optical films may focus the broad light distribution toward the LCD panel 60. Such optical films may generally increase the “on-axis” brightness, which represents the brightness of the backlight unit 62 along a normal incident to an upper surface of the backlight unit 62. As such, an additional heat cure binder (not shown) may be applied on the top side of the diffuser 74.

The light guide plate 70 may include the light guide scratch protection component 20 to prevent the beads 78 from scratching the light guide plate 70 during vibrations. The light guide plate scratch protection component 20 may represent, for example, a molded pattern on the upper face of the light guide plate 70 (e.g., as shown in FIG. 6) or a protective layer such as a nonstick (e.g., Teflon) or a self-healing coating (e.g., as shown in FIG. 8).

Indeed, FIG. 6 provides an example of a cut-away side view of the backlight unit 62. As such, it should be understood that the light guide plate 70 and the diffuser 74 are separated from one another only for ease of explanation. In the example of FIG. 6, the light guide plate 70 includes a molded pattern 90 that serves as the light guide plate scratch protection component 20. The molded pattern 90 may generally be formed in a similar manner to the molded pattern 76 that appears on the bottom face of the light guide plate 70. In general, the molded pattern 90 is believed to slightly increase the spacing between the diffuser 74 and much of the upper face of the light guide plate 70. Thus, it is believed that the beads 78 may apply less pressure to the upper face of the light guide plate 70 and thus may be less likely to scratch the light guide plate 70.

The molded pattern 90 on the light guide plate 70 may be shaped as convex bumps on the upper face of the light guide plate 70. The size and/or shape of the molded pattern 90 may or may not be selected in relation to other components of the backlight unit 62. As seen in FIG. 6, the molded pattern 76 may include molded convex bumps that extend a distance D1 away from the light diffuser plate 70. The molded pattern 90 may include molded convex bumps that extend a distance D2 from the light diffuser plate 70. The beads 78 may have a diameter of a distance D3, thereby extending the distance D3 from diffuser 74. To provide a few examples, the distance D2 of the convex bumps of the light guide plate 70 may be a relatively constant value between 1-50 μm, 10-40 μm, 30-40 μm, or approximately 35 μm. In other examples, the distance D2 may vary from convex bump to convex bump between 1-50 μm, 10-40 μm, or 30-40 μm. In either case, the presence of the convex bumps of the molded pattern 90 may reduce the likelihood that the light guide plate 70 will be scratched when the backlight unit 62 moves.

In some examples, the distance D2 may be smaller than the distance D1. The distance D3 may be smaller, larger, or approximately equal to the distance D2. The precise size of the convex bumps of the molded pattern 90 that best reduces scratches on the light guide plate 70 may be determined experimentally or through computer modeling. In general, the convex bumps of the molded pattern 90 may take generally the same shape as the molded pattern 76, but may be the same size or smaller. It may also be noted that, although the diffuser 74 could be patterned with the molded pattern 90 instead of the light guide plate 70, the molding on the light guide plate 70 generally may be more stable.

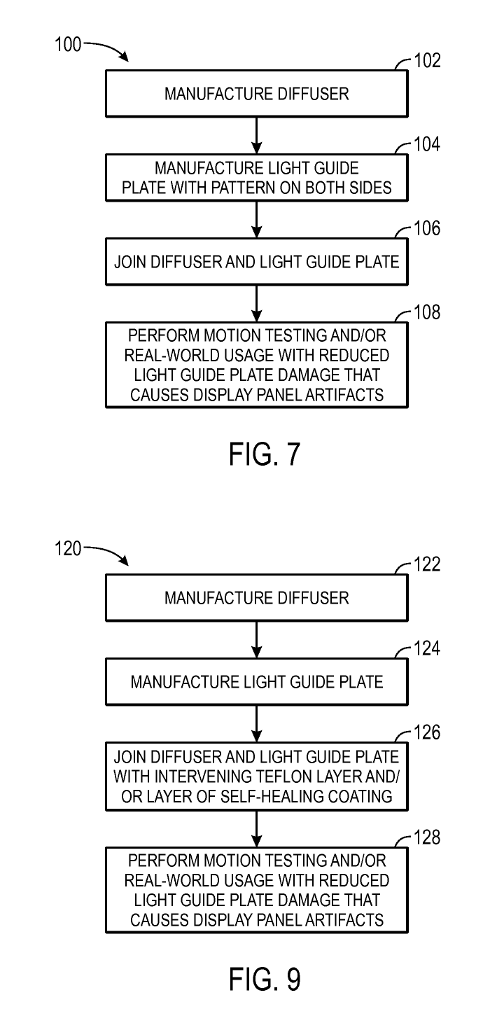

The backlight unit 62 shown in FIG. 6 may be manufactured according to a flowchart 100 of FIG. 7. Specifically, the diffuser 74 may be manufactured (block 102). The light guide plate 70 may also be manufactured, molding the patterns 76 and 90 on the respective lower and upper faces of the light guide plate 70 (block 104). The molded pattern 90 may be formed when the material to form the light guide plate 70 is injected into a steel mold. Initially creating, in the steel mold, the pattern that will produce the molded pattern 90 may involve a laser process. Namely, a laser may cut into the steel mold a very small pattern inverse to the resulting molded pattern 90. Additionally or alternatively, the molded pattern 90 may be formed on the light guide plate 70 using photolithography to etch the light guide plate 70.

The light guide plate 70 and the diffuser 74 may be joined together with the binder 80 and the beads 78 located in the interface between the diffuser 74 and the light guide plate 70 (block 106). Thereafter, motion testing and/or real-world usage may occur with a reduced likelihood that the light guide plate 70 will become scratched (block 108). Thus, despite rapid motion of the backlight unit 62, the backlight unit 62 will be less likely to produce “white spot” artifacts owing to scratching of the light guide plate 70.

Additionally or alternatively, the light guide plate scratch protection component 20 may represent a protective layer 110, as shown in FIG. 8. Although the protective layer 110 is shown in FIG. 8 as occurring exclusive of the molded pattern 90, it should be appreciated that the protective layer 110 may be used in combination with the molded pattern 90 in some embodiments. The protective layer 110 may represent a nonstick (e.g., Teflon) coating or a self-healing coating. When the protective layer 110 represents a nonstick coating such as Teflon, pressure from the beads 78 on the protective layer 110 may not produce any significant scratching owing to the friction-reducing properties and/or strength of the nonstick coating. When the protective layer 110 represents a self-healing coating, the beads 78 may scratch the protective layer 110, but the protective layer 110 may self-heal, negating the effects of such scratching. Such a self-healing coating may be, for example, Self Healing Cure by Natoco Co., Ltd. or a similar material.

Additionally or alternatively, the protective layer 110 may include both a nonstick (e.g., Teflon) coating and a self-healing coating. For example, a nonstick (e.g., Teflon) coating may be installed on the upper face of the light guide plate 70 and the self-healing coating placed on top of the nonstick (e.g., Teflon) coating. For such an embodiment, the beads 78 may be likely to scratch the self-healing coating, though to little avail, as they may be unlikely to reach through the nonstick (e.g., Teflon) coating on the light guide plate 70. In another example, a self-healing coating may be installed on the upper face of the light guide plate 70 and a nonstick (e.g., Teflon) coating placed on top of the self-healing coating. Thus, if the beads 78 happened to scratch through the nonstick (e.g., Teflon) coating and into the self-healing coating, the self-healing coating may fill in the scratched location.

The thickness of the protective coating 110 on the light guide plate 70 is illustrated as a distance D4 on top of the light guide plate 70. The distance D4 may vary depending on whether the protective coating 110 represents a nonstick (e.g., Teflon) coating, a self-healing coating, or a combination of these. For instance, a nonstick (e.g., Teflon) coating may have a varying thickness of between 5-50 μm, 20-40 μm, or a relatively constant thickness of some value between 5-50 μm. A self-healing coating may have a varying thickness of between 2-50 μm, 20-40 μm, or a relatively constant thickness of some value between 2-50 μm. A combination of a nonstick (e.g., Teflon) coating and a self-healing coating may have a total thickness less than 50 μm in some embodiments, though in other embodiments the total thickness may be greater.

The backlight unit 62 of FIG. 8 may be manufactured according to a flowchart 120 shown in FIG. 9. In the flowchart 120, the diffuser 74 may be manufactured (block 122), as may be the light guide plate 70 (block 124). The light guide plate 70 may or may not be manufactured to include the molded pattern 90. When the light guide plate 70 and the diffuser 74 are to be joined, the beads 78 and binder material 80 may be applied to the diffuser 74 and the protective layer 110—that is, a nonstick (e.g., Teflon) coating, a self-healing coating, or some combination of these—may be applied to the light guide plate 70. The protective layer 110 may be applied as a sheet, sprayed onto the light guide plate 70, or applied using any other suitable technique to the upper face of the light guide plate 70 (e.g., slit coating). Having joined the light guide plate 70 to the diffuser 74 in this way, the backlight unit 62 may thereafter undergo motion testing and/or real-world usage with a reduced likelihood of scratching damage to the light guide plate 70.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A backlight unit for a liquid crystal display, comprising:
a light source;
a light guide plate configured to convey light generated by the light source;
a diffuser configured to diffuse the light conveyed by the light guide plate; and
a light guide plate scratch protection component comprising:
a first pattern of generally rounded convex bumps formed in a surface of the light guide plate that faces the diffuser;
a self-healing coating disposed directly on the surface of the light guide plate that faces the diffuser; or
a nonstick coating disposed directly on the surface of the light guide plate that faces the diffuser; or
any combination thereof.

2. The backlight unit of claim 1, wherein the light guide plate comprises a second pattern of convex bumps on a surface opposite the surface of the light guide plate that faces the diffuser, wherein the second pattern of convex bumps is substantially identical to the first pattern of convex bumps.

3. The backlight unit of claim 1, wherein the light guide plate comprises a second pattern of convex bumps on a surface of the light guide plate that is opposite the surface of the light guide plate that faces the diffuser, wherein the first pattern of convex bumps comprises convex bumps having a smaller diameter than those of the second pattern of convex bumps.

4. The backlight unit of claim 1, wherein the light guide plate comprises a second pattern of convex bumps on a surface of the light guide plate that is opposite the surface of the light guide plate that faces the diffuser, wherein convex bumps of the first and second patterns of convex bumps differ substantially only in diameter.

5. The backlight unit of claim 1, comprising a binder material and beads disposed between the light guide plate scratch protection component and the diffuser, wherein the light guide plate scratch protection component is configured to prevent scratches on the light guide plate caused by the beads by:
preventing the beads from penetrating the light guide plate scratch protection component;
producing lower friction between the beads and the light guide plate scratch protection component than would occur between the beads and the light guide plate were the light guide plate scratch protection component not present;
allowing the beads to penetrate the light guide plate scratch protection component but causing the light guide plate scratch protection component to self-heal; or
allowing the beads to penetrate the light guide plate but causing the light guide plate to be filled in by the light guide plate scratch protection component where the beads penetrate the light guide plate; or
any combination thereof.

6. The backlight unit of claim 1, wherein the nonstick coating comprises a Teflon coating.

7. A method for manufacturing a backlight unit for an electronic display comprising:
providing a diffuser;
providing a light guide plate comprising convex bumps on a display-panel-facing surface of the light guide plate and on a surface of the light guide plate opposite the display-panel-facing surface; and
joining the diffuser to the display-panel-facing surface of the light guide plate.

8. The method of claim 7, wherein the provided light guide plate has been manufactured using a mold having laser-cut pattern inverse to that of the convex bumps on at least the display-panel-facing surface of the light guide plate.

9. The method of claim 7, wherein the provided light guide plate has been manufactured by:
molding the light guide plate without at least the convex bumps on the display-panel-facing surface of the light guide plate; and
etching at least the convex bumps on the display-panel-facing surface of the light guide plate using photolithography.

10. The method of claim 7, wherein the provided light guide plate comprises the convex bumps on the display-panel-facing surface of the light guide plate, wherein the convex bumps have a diameter of between approximately 1-50 μm.

11. The method of claim 7, wherein the provided light guide plate comprises the convex bumps on the display-panel-facing surface of the light guide plate, wherein the convex bumps have a diameter of between approximately 10-40 μm.

12. The method of claim 7, wherein the provided light guide plate comprises the convex bumps on the display-panel-facing surface of the light guide plate, wherein the convex bumps have a diameter of between approximately 30-40 μm.

13. The method of claim 7, wherein the provided light guide plate comprises the convex bumps on the display-panel-facing surface of the light guide plate, wherein the convex bumps have a diameter of approximately 35 μm.

14. The method of claim 7, wherein the provided light guide plate comprises the convex bumps on the display-panel-facing surface of the light guide plate, wherein the convex bumps have varying diameters to reduce the likelihood that the light guide plate will be scratched by the diffuser.

15. The method of claim 7, wherein the diffuser is joined to the display-panel-facing surface of the light guide plate via a binder material and anti-wetting beads, wherein the beads are of a material harder than the light guide plate.

16. A method for manufacturing a backlight unit for an electronic display comprising:
providing a diffuser;
providing a light guide plate;
providing a protective layer, wherein the protective layer comprises a Teflon coating, a self-healing coating, or both;
joining the protective layer to the light guide plate; and
joining the diffuser to the protective layer.

17. The method of claim 16, wherein the protective layer comprises the Teflon coating and wherein the Teflon coating has a thickness of between approximately 5-50 μm.

18. The method of claim 16, wherein the protective layer comprises the self-healing coating and wherein the self-healing coating has a thickness of between approximately 2-50 μm.

19. The method of claim 16, wherein the protective layer comprises both the Teflon coating and the self-healing coating, and wherein the protective layer has a total thickness of less than approximately 50 μm.

20. An electronic display comprising:
a display panel; and
a backlight component configured to light the display panel, the backlight component comprising:
a light source;
a light guide plate configured to convey light generated by the light source;
a diffuser configured to diffuse the light conveyed by the light guide plate;
a binder and beads disposed on the diffuser; and
a light guide plate scratch protection component disposed directly on the light guide plate and configured to prevent scratches on the light guide plate caused by the beads by:
preventing the beads from penetrating the light guide plate scratch protection component;
producing lower friction between the beads and the light guide plate scratch protection component than would occur between the beads and the light guide plate were the light guide plate scratch protection component not present;
allowing the beads to penetrate the light guide plate scratch protection component but causing the light guide plate scratch protection component to self-heal; or
allowing the beads to penetrate the light guide plate but causing the light guide plate to be filled in by the light guide plate scratch protection component where the beads penetrate the light guide plate; or
any combination thereof.

21. The electronic display of claim 20, wherein the light guide plate scratch protection component comprises a material that is harder than the light guide plate.

22. The electronic display of claim 21, wherein the light guide plate comprises polymethyl-methacrylate.

23. The electronic display of claim 20, wherein the light guide plate scratch protection component comprises a nonstick coating, a self-healing coating, or a combination thereof.

24. An electronic device comprising:
a processor configured to generate image data; and
a display configured to display the image data, the display comprising:
a liquid crystal display panel; and
a backlight unit to provide light to the liquid crystal display panel, the backlight unit comprising a light guide plate and a diffuser separated at least partly by a light guide plate scratch protection component, wherein the light guide plate scratch protection component comprises:
a first pattern of convex bumps formed in a surface of the light guide plate that faces the diffuser;
a self-healing coating disposed between the surface of the light guide plate that faces the diffuser and the diffuser; or
a nonstick coating disposed between the surface of the light guide plate that faces the diffuser and the diffuser; or
any combination thereof.

25. The electronic device of claim 24, wherein the light guide plate scratch protection component comprises both the self-healing coating and the nonstick coating.

26. The electronic device of claim 25, wherein the self-healing coating is disposed directly on the surface of the light guide plate that faces the diffuser and the nonstick coating is disposed directly on the self-healing coating.

27. The electronic device of claim 25, wherein the nonstick coating is disposed directly on the surface of the light guide plate that faces the diffuser and the self-healing coating is disposed directly on the nonstick coating.
